(19) United States
(12) Patent Application Publication
(10) Pub. No.: US 2026/0296025 A1
(43) Pub. Date: Oct. 1, 2026

(54) LIQUID EJECTION DEVICE AND NOZZLE SURFACE CLEANING METHOD

(71) Applicant: SEIKO EPSON CORPORATION, TOKYO (JP)

(72) Inventor: Kazuyoshi TANASE, MATSUMOTO-SHI (JP)

(21) Appl. No.: 19/632,664

(22) Filed: Mar. 30, 2026

(30) Foreign Application Priority Data
Mar. 28, 2025 (JP) 2025-055268

(51) Int. Cl. B41J 2/165

(52) U.S. Cl. CPC B41J 2/16511; B41J 2/16579

(57) ABSTRACT

A liquid ejection device includes an ejection head including a nozzle surface in which is formed a nozzle that ejects liquid; a cap configured to seal the nozzle; a water absorbing member having a water absorbing property; a supply section that supplies, to the water absorbing member, a removal accelerating agent that accelerates removal of a solid substance resulting from solidification of liquid clinging to the nozzle surface; a first movement section configured to move at least one of the ejection head and the cap between a sealing position where the cap seals the nozzle and a separation position where the cap is separated from the nozzle; and a second movement s configured to move the water absorbing member to a position between the nozzle surface and the cap. The second movement section is configured to, by moving the water absorbing member, switch the water absorbing member between a first state in which the water absorbing member is positioned between the nozzle surface and the cap and a second state in which the water absorbing member is not positioned between the nozzle surface and the cap.

The present application is based on, and claims priority from JP Application Serial Number 2025-055268, filed Mar. 28, 2025, the disclosure of which is hereby incorporated by reference herein in its entirety.

### BACKGROUND

### 1. Technical Field

The present disclosure relates to a liquid ejection device and a nozzle surface cleaning method.

### 2. Related Art

For example, JP-A-2014-172238 discloses a liquid ejection device that ejects liquid from nozzles of an ejection head. In such a liquid ejection device, a nozzle surface of the ejection head is wiped using washing liquid, and thus the washing liquid is applied and spread on the nozzle surface.

However, in such a liquid ejection device, when liquid clinging to the nozzle surface is solidified as a solid substance, it is not easy to remove the solid substance even if washing liquid is used. Therefore, it is desired to improve the convenience of a worker.

### SUMMARY

A liquid ejection device that overcomes the above-described problem is a liquid ejection device including an ejection head including a nozzle surface in which is formed a nozzle that ejects liquid; a cap configured to seal the nozzle; a water absorbing member having a water absorbing property; a supply section that supplies, to the water absorbing member, a removal accelerating agent that accelerates removal of a solid substance resulting from solidification of liquid clinging to the nozzle surface; a first movement section configured to move at least one of the ejection head and the cap between a sealing position where the cap seals the nozzle and a separation position where the cap is separated from the nozzle; and a second movement section configured to move the water absorbing member to a position between the nozzle surface and the cap, wherein the second movement section is configured to, by moving the water absorbing member, switch the water absorbing member between a first state in which the water absorbing member is positioned between the nozzle surface and the cap and a second state in which the water absorbing member is not positioned between the nozzle surface and the cap.

A nozzle surface cleaning method that overcomes the above-described problem is a nozzle surface cleaning method for a printing device that includes an ejection head including a nozzle surface in which is formed a nozzle that ejects liquid, a cap configured to seal the nozzle, and a movement section configured to move at least one of the ejection head and the cap between a sealing position where the cap seals the nozzle and a separation position where the cap is separated from the nozzle, the nozzle surface cleaning method including a step of moving at least one of the ejection head and the cap so that the cap is positioned at the separation position separated from the nozzle; a step of bringing the water absorbing member, which absorbed a removal accelerating agent that accelerates removal of a solid substance resulting from solidification of liquid clinging to the nozzle surface, into contact with the nozzle surface; a step of moving at least one of the ejection head and the cap or moving the water absorbing member so that the water absorbing member is not in contact with the nozzle surface; and a step of performing flushing in which liquid is ejected from the nozzle.

### BRIEF DESCRIPTION OF THE DRAWINGS

FIG. 1 is a schematic diagram illustrating a liquid ejection device according to a first embodiment.

FIG. 2 is a schematic diagram illustrating a second cleaning according to the first embodiment.

FIG. 3 is a schematic diagram illustrating a water absorbing member and a second movement section according to the first embodiment.

FIG. 4 is a schematic diagram illustrating the water absorbing member and the second movement section according to the first embodiment.

FIG. 5 is a flowchart illustrating a maintenance process according to the first embodiment.

FIG. 6 is a flowchart illustrating a maintenance process according to a second embodiment.

FIG. 7 is a schematic diagram illustrating a water absorbing member and a second movement section according to a third embodiment.

### DESCRIPTION OF EMBODIMENTS

### First Embodiment

Hereinafter, an embodiment of a liquid ejection device and a nozzle surface cleaning method will be described with reference to the drawings. In the following description, a scanning direction of a carriage in the liquid ejection device is defined as an X-axis. An axis intersecting the X-axis is defined as a Y-axis. An axis intersecting the X-axis and the Y-axis is defined as a Z-axis. One direction along the X-axis is defined as a first scanning direction X1, and the other direction along the X-axis is defined as a second scanning direction X2. One direction along the Y-axis is defined as a first width direction Y1, and the other direction along the Y-axis is defined as a second width direction Y2. One direction along the Z-axis is defined as an upward direction Z1, and the other direction along the Z-axis is defined as a downward direction Z2.

### Configuration of Liquid Ejection Device 11

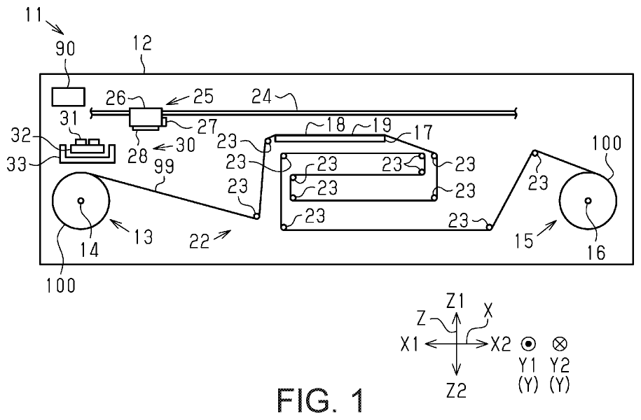

As illustrated in FIG. 1, a liquid ejection device 11 performs printing on a medium 99 by ejecting liquid onto the medium 99. The liquid ejection device 11 may be an inkjet printer that ejects ink, which is an example of liquid, onto the medium 99. The liquid may include, for example, liquid that is cured by irradiation with ultraviolet rays.

The liquid ejection device 11 includes a housing 12. The liquid ejection device 11 includes a medium feed section 13. The medium feed section 13 is configured to feed the medium 99. The medium feed section 13 is accommodated in the housing 12, for example. The medium feed section 13 includes a medium feed shaft 14. The medium feed shaft 14 rotatably holds a roll body 100 around which the medium 99 is wound. The medium feed shaft 14 holds the medium 99 before printing. As the medium feed shaft 14 rotates, the medium 99 is fed from the medium feed section 13. The medium feed shaft 14 may be driven to rotate by a motor (not illustrated) or may be driven to rotate as the medium 99 is pulled.

The liquid ejection device 11 includes a medium winding section 15. The medium winding section 15 is configured to wind the medium 99. The medium winding section 15 is accommodated in the housing 12, for example. The medium winding section 15 includes a medium winding shaft 16. The medium winding shaft 16 rotatably holds the roll body 100, similarly to the medium feed shaft 14. The medium winding shaft 16 holds the medium 99 after printing. As the medium winding shaft 16 rotates, the medium winding section 15 winds the medium 99. The medium winding shaft 16 is driven to rotate by, for example, a motor (not illustrated).

The liquid ejection device 11 includes a medium support section 17. The medium support section 17 supports the medium 99. The medium support section 17 is accommodated in the housing 12, for example. The medium support section 17 supports, for example, the medium 99 from the downward direction Z2. The medium support section 17 supports the medium 99 in a process from when the medium 99 is fed from the medium feed section 13 to when the medium 99 is wound around the medium winding section 15.

The medium support section 17 includes a support surface 18. The support surface 18 is a surface of the medium support section 17 that comes into contact with the medium 99. The support surface 18 faces, for example, in the upward direction Z1 in the medium support section 17. When the medium support section 17 is viewed from the upward direction Z1, the support surface 18 overlaps the medium 99. A region of the medium 99 supported by the medium support section 17 is a print region 19. In the liquid ejection device 11, printing is performed on the print region 19 of the medium 99.

The liquid ejection device 11 includes a transport section 22. The transport section 22 is configured to transport the medium 99. The transport section 22 is accommodated in the housing 12, for example. The transport section 22 transports the medium 99 from the medium feed section 13 toward the medium winding section 15. The transport section 22 transports the medium 99 on the medium support section 17 in the second scanning direction X2.

The transport section 22 transports a portion of the medium 99 that passed on the medium support section 17 in the downward direction Z2 from the medium support section 17. That is, the printed medium 99 is transported by the transport section 22 from the medium support section 17 in the downward direction Z2 from the medium support section 17.

The transport section 22 intermittently transports the medium 99. That is, the transport section 22 repeats the start of transport and the stop of transport. The transport section 22 stops the transport of the medium 99 when printing of the medium 99 is being executed. The transport section 22 starts transporting the medium 99 when printing of the medium 99 is not being executed. In the liquid ejection device 11, printing of the medium 99 and the transport of the medium 99 are alternately repeated.

The transport section 22 includes one or more transport rollers 23. The transport roller 23 is positioned, for example, inside the housing 12. The transport roller 23 transports the medium 99 by rotating. The medium 99 is wound around the transport roller 23. The transport roller 23 may sandwich the medium 99. The medium 99 is transported by the rotation of the transport roller 23. The transport roller 23 includes, for example, a roller that is driven to rotate by a motor (not illustrated). The transport roller 23 is positioned, for example, in the downward direction Z2 with respect to the support surface 18.

The liquid ejection device 11 includes a first guide 24. The first guide 24 is accommodated in the housing 12. The first guide 24 is supported in the housing 12, for example. The first guide 24 extends along the X-axis. The first guide 24 extends, for example, along the X-axis in a region in the upward direction Z1 with respect to the medium support section 17. The first guide 24 is, for example, a rod that is long along the X-axis.

The liquid ejection device 11 includes a printing section 25. The printing section 25 is supported by the first guide 24. The printing section 25 is configured to print on the medium 99. The printing section 25 performs printing on the medium 99 by ejecting liquid onto the medium 99. The printing section 25 performs printing on the print region 19. The printing section 25 is accommodated in the housing 12, for example. The printing section 25 includes a carriage 26 and one or more ejection heads 28. That is, the liquid ejection device 11 includes the ejection head 28. The carriage 26 and the ejection head 28 are positioned in the upward direction Z1 with respect to the medium support section 17, for example.

The carriage 26 is equipped with the ejection head 28. The carriage 26 is configured to move relative to the medium 99. The carriage 26 moves relative to the print region 19. The carriage 26 moves in a region facing the medium support section 17. In a case where the medium support section 17 is viewed in plan view, the carriage 26 moves so as to pass through the print region 19. The carriage 26 moves in a region in the upward direction Z1 relative to the medium support section 17, for example.

The carriage 26 is supported by the first guide 24. The carriage 26 moves along the first guide 24. Therefore, the carriage 26 moves along the X-axis, for example. Specifically, the carriage 26 reciprocates along the X-axis. That is, the carriage 26 moves in the first scanning direction X1 and the second scanning direction X2. Therefore, the carriage 26 moves in a direction in which the medium 99 moves on the medium support section 17. Therefore, the liquid ejection device 11 is a so-called lateral printer.

The printing section 25 may include a curing section 27. The curing section 27 may be mounted on the carriage 26. A plurality of curing sections 27 may be mounted on the carriage 26. The curing section 27 applies energy to the medium 99 printed in the print region 19. The curing section 27 may be configured to irradiate ultraviolet rays as energy. By this, the curing section 27 cures the liquid deposited to the medium 99.

The ejection head 28 may be a piezo head using a piezo element. The piezo element has a piezoelectric effect of generating a voltage by applying a pressure and an inverse piezoelectric effect of deforming by applying a voltage. That is, the ejection head 28 has the piezoelectric effect and the inverse piezoelectric effect.

The ejection head 28 includes, for example, an actuator (not illustrated) as the piezo element. The actuator generates a voltage when a pressure is applied thereto when the ejection head 28 ejects liquid.

The liquid ejection device 11 includes a maintenance region 30. The maintenance region 30 is a region where maintenance of a nozzle 29 is performed. The maintenance region 30 is a region on a first scanning direction X1 side with respect to the print region 19. The maintenance region 30 is a region in the downward direction Z2 with respect to the carriage 26.

The liquid ejection device 11 includes a control section 90. The control section 90 generally controls the liquid ejection device 11. The control section 90 controls various operations executed by the liquid ejection device 11. The control section 90 can be configured as a circuit that includes a: one or more processors that execute various processes in accordance with computer programs, B: one or more dedicated hardware circuits that execute at least some of the various processes, or y: a combination thereof. The hardware circuit is, for example, an application specific integrated circuit. The processor includes a CPU and a memory, such as a RAM and a ROM, and the memory stores program code or commands configured to cause the CPU to execute processes. Memory or computer readable medium includes any readable medium that can be accessed by a general-purpose or dedicated computer.

The control section 90 displays various types of information on a display section (not illustrated). The control section 90 receives an instruction from a worker via an operation section (not illustrated). The worker may include a user who performs printing on the medium 99 using the liquid ejection device 11. The worker may include a service person who maintains and inspects the liquid ejection device 11. The liquid ejection device 11 may be capable of communicating with a terminal device (not illustrated). The liquid ejection device 11 may cause the terminal device to display various types of information.

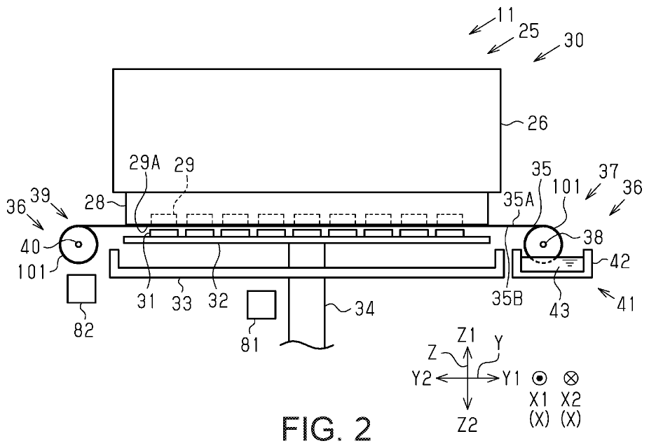

As illustrated in FIG. 2, the ejection head 28 includes the nozzle 29. The ejection head 28 may include the plurality of nozzles 29. The nozzle 29 is configured to eject liquid onto the medium 99. The nozzle 29 ejects liquid onto the medium 99 in the print region 19. The nozzle 29 includes an opening through which liquid is ejected.

The ejection head 28 includes a nozzle surface 29A in which the nozzles 29 are formed. The nozzle surface 29A faces the medium 99 in the print region 19. That is, the nozzle surface 29A is provided on a downward direction Z2 side of the ejection head 28.

The liquid ejection device 11 includes a cap 31, a cap support section 32, a flushing receiving section 33, and a first movement section 34. The liquid ejection device 11 may include a plurality of caps 31. The cap 31, the cap support section 32, the flushing receiving section 33, and the first movement section 34 are provided in the maintenance region 30.

The cap 31 is provided in the upward direction Z1 of the cap support section 32. The plurality of caps 31 are provided one by one for the plurality of nozzles 29 formed in the ejection head 28. The cap 31 is configured to be able to seal the nozzle 29. The cap 31 may be a close-fitting cap that seals the opening of the nozzle 29 from the downward direction Z2 with respect to the nozzle 29. The cap 31 may have a flat plate shape.

The cap support section 32 supports the cap 31 from the downward direction Z2. The cap support section 32 may have a rectangular parallelepiped shape extending on an XY plane including the X-axis and the Y-axis. The cap support section 32 is provided so as to be movable in a direction along the upward direction Z1.

The flushing receiving section 33 is a member that receives liquid by flushing from the ejection head 28. The flushing suppresses clogging of the nozzles 29. The flushing is an operation of appropriately ejecting liquid from the nozzle 29.

The flushing receiving section 33 is positioned, for example, upstream of the medium support section 17 in the second scanning direction X2. The flushing receiving section 33 may be positioned downstream of the medium support section 17 in the second scanning direction X2.

The flushing receiving section 33 faces the ejection head 28 when the carriage 26 is positioned at a flushing position. The flushing receiving section 33 is positioned in the downward direction Z2 of the cap 31 and the cap support section 32.

The first movement section 34 moves the cap support section 32 in a direction along the Z-axis. That is, the first movement section 34 moves the cap 31 in a direction along the Z-axis. In particular, the first movement section 34 is capable of moving the cap 31 between a sealing position and a separation position. The sealing position is a position at which the cap 31 seals the nozzle 29. The separation position is a position where the cap 31 is separated from the nozzle 29. The separation position may be positioned in the downward direction Z2 with respect to the sealing position.

In this way, the first movement section 34 can move the cap 31 toward the ejection head 28. By this, the first movement section 34 moves the ejection head 28 and the cap 31 closer to each other. The first movement section 34 can move the cap 31 to a side opposite to an ejection head 28 side. By this, the first movement section 34 separates the ejection head 28 and the cap 31 from each other. The first movement section 34 may be connected to a downward direction Z2 side of the cap support section 32.

The liquid ejection device 11 includes a first motor 81. The first motor 81 may be a motor that drives the first movement section 34. The first motor 81 is connected to the first movement section 34. The first motor 81 moves the first movement section 34 in a direction along the upward direction Z1. That is, the first movement section 34 may move the cap support section 32 up and down by driving the first motor 81, for example.

The liquid ejection device 11 includes a water absorbing member 35. The water absorbing member 35 is provided in the maintenance region 30. The water absorbing member 35 has a water absorbing property. The water absorbing member 35 may be a cloth or a sponge. The water absorbing member 35 includes a first surface 35A and a second surface 35B. The first surface 35A is a surface that comes into contact with the nozzle surface 29A. The second surface 35B is a surface that comes into contact with the cap 31. The water absorbing member 35 may remove liquid clinging to the nozzle 29 by the first surface 35A coming into contact with the nozzle surface 29A.

The liquid ejection device 11 includes a second movement section 36. The second movement section 36 is configured to be able to move the water absorbing member 35 between the nozzle surface 29A and the cap 31. The second movement section 36 is controlled by the control section 90.

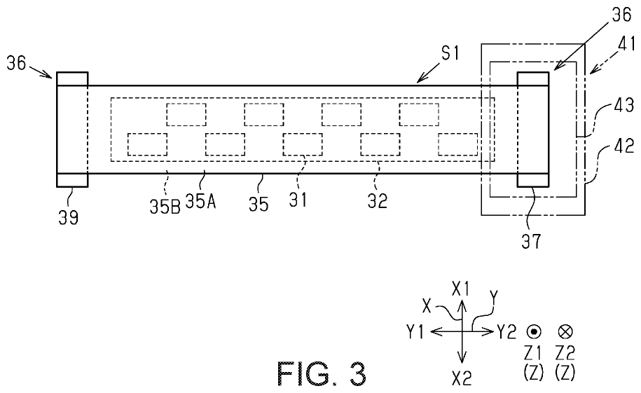

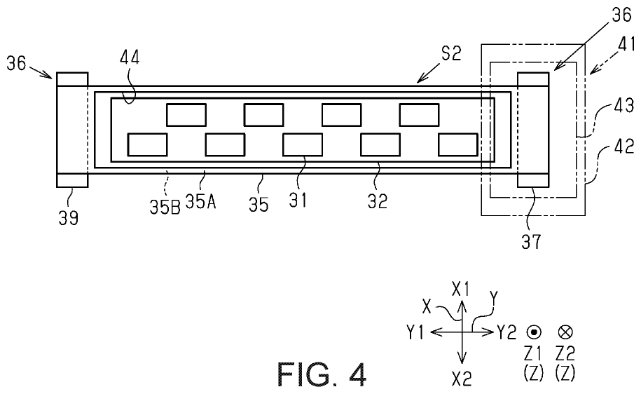

The second movement section 36 includes a water absorbing member feed section 37 and a water absorbing member winding section 39. The water absorbing member feed section 37 is configured to feed the water absorbing member 35. The water absorbing member feed section 37 includes a water absorbing member feed shaft 38. The water absorbing member feed shaft 38 rotatably holds a roll body 101 around which the water absorbing member 35 is wound. The water absorbing member feed shaft 38 holds the water absorbing member 35 before being used for cleaning. The water absorbing member 35 will be described later with reference to FIGS. 3 and 4. As the water absorbing member feed shaft 38 rotates, the water absorbing member 35 is fed from the water absorbing member feed section 37.

The water absorbing member winding section 39 is configured to wind the water absorbing member 35. The water absorbing member winding section 39 includes a water absorbing member winding shaft 40. The water absorbing member winding shaft 40 rotatably holds the roll body 101, similarly to the water absorbing member feed shaft 38. The water absorbing member winding shaft 40 holds the water absorbing member 35 after being used for cleaning. As the water absorbing member winding shaft 40 rotates, the water absorbing member winding section 39 winds the water absorbing member 35.

The liquid ejection device 11 includes a second motor 82. The second motor 82 may be a motor that drives the water absorbing member feed shaft 38 and the water absorbing member winding shaft 40, which will be described later. The second motor 82 is connected to the water absorbing member feed shaft 38 and the water absorbing member winding shaft 40. The second motor 82 moves the water absorbing member 35 in the second width direction Y2. That is, the water absorbing member winding shaft 40 is driven to rotate by, for example, the second motor 82. The water absorbing member feed shaft 38 may be driven to rotate by the second motor 82, or may be driven to rotate as the water absorbing member 35 is pulled.

The liquid ejection device 11 includes a supply section 41. The supply section 41 includes a storage tank 42. The storage tank is configured to store a removal accelerating agent 43. The storage tank 42 is positioned in the downward direction Z2 of the water absorbing member feed section 37. The storage tank 42 is provided such that at least a part of the roll body 101 of the water absorbing member feed section 37 positioned in the upward direction Z1 is immersed in the removal accelerating agent 43. That is, the supply section 41 supplies the removal accelerating agent 43 to the water absorbing member 35.

The removal accelerating agent 43 accelerates removal of a solid substance that is solidified by liquid clinging to the nozzle surface 29A. The removal accelerating agent 43 is absorbed by the roll body 101 wound around the water absorbing member feed shaft 38. The removal accelerating agent 43 is absorbed by the water absorbing member 35 in the water absorbing member feed section 37. That is, the water absorbing member 35 absorbs the removal accelerating agent 43 in the water absorbing member feed section 37.

The removal accelerating agent 43 may be dissolving liquid that dissolves a solid substance that is solidified by liquid clinging to the nozzle surface 29A. The removal accelerating agent 43 may be a peeling agent that peels off a solid substance that is solidified by liquid clinging to the nozzle surface 29A.

As illustrated in FIG. 3, when the water absorbing member 35 overlaps the cap 31 in the Z-axis, the water absorbing member 35 is in a first state S1. The first state S1 is a state in which the water absorbing member 35 is positioned between the nozzle surface 29A and the cap 31.

As illustrated in FIG. 4, the water absorbing member 35 is provided with an opening section 44. That is, the water absorbing member 35 includes the opening section 44. The opening section 44 is provided in a part of the water absorbing member 35. When the opening section 44 and the cap 31 overlap each other in the Z-axis, the water absorbing member 35 is in a second state S2. That is, the second state S2 is a state in which the water absorbing member 35 is not positioned between the nozzle surface 29A and the cap 31. Specifically, the second movement section 36 can set the water absorbing member 35 to the second state S2 by moving the water absorbing member 35 so that the opening section 44 is positioned between the nozzle surface 29A and the cap 31.

The water absorbing member 35 is provided with the opening section 44 so that the first state S1 and the second state S2 appear alternately. By this, the second movement section 36 can switch between the first state S1 and the second state S2 by moving the water absorbing member 35. The intervals at which the opening sections 44 are provided can be set arbitrarily and are not limited to equal intervals.

### Maintenance Process

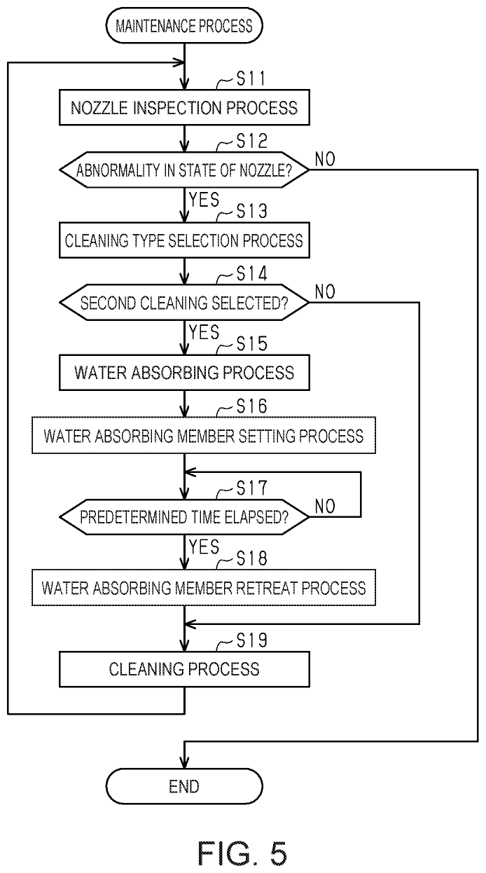

A maintenance process will be described with reference to FIG. 5. The maintenance process is a process executed by the control section 90 at predetermined intervals. That is, the control section 90 can execute the maintenance process. The maintenance process will be described on the assumption that the cap 31 is arranged at the sealing position and the water absorbing member 35 is in the second state S2.

In step S11, the control section 90 executes a nozzle inspection process. The nozzle inspection process is a process of inspecting a state of the nozzle 29. In this process, the control section 90 detects a state of the nozzle 29 without the intervention of a worker. The control section 90 can indirectly inspect a state of the nozzle 29 by detecting a signal from the actuator.

In step S12, the control section 90 determines whether or not there is an abnormality in a state of the nozzle 29. When a signal from the actuator is equal to or larger than a certain threshold, the control section 90 determines that there is an abnormality in a state of the nozzle 29. When a signal from the actuator is less than a certain threshold, the control section 90 determines that there is no abnormality in a state of the nozzle 29.

When the control section 90 determines that there is an abnormality in a state of the nozzle 29, the control section 90 shifts the process to step S13. When the control section 90 determines that there is no abnormality in a state of the nozzle 29, the control section 90 ends the maintenance process.

In step S13, the control section 90 executes a cleaning type selection process. In this process, the control section 90 receives an instruction of a cleaning type from a worker. The control section 90 may cause a display section (not illustrated) to display an image for prompting a worker to instruct a cleaning type. The control section 90 may receive an instruction from a worker through an operation section (not illustrated). In the cleaning type selection process, a worker can select a first cleaning and a second cleaning.

In step S14, the control section 90 determines whether or not the second cleaning is selected. When the control section 90 determines that the second cleaning is selected, the control section 90 shifts the process to step S15. When the control section 90 determines that the second cleaning is not selected, the control section 90 shifts the process to step S19.

In step S15, the control section 90 executes a water absorbing process. In this process, the control section 90 applies the removal accelerating agent 43 to the water absorbing member 35. When the removal accelerating agent 43 has already been supplied to the water absorbing member 35, the control section 90 may immediately shift the process to step S16.

In step S16, the control section 90 executes a water absorbing member setting process. In this process, the control section 90 controls the first motor 81 to move the cap 31 to the separation position. The control section 90 controls the second motor 82 such that the water absorbing member 35 is in the first state S1. By this, the second movement section 36 sets the water absorbing member 35 to the first state S1. The control section 90 controls the first motor 81 to move the cap 31 from the separation position to the sealing position. In this manner, the water absorbing member 35 is in the first state S1 and is in a state of being sandwiched between the nozzle surface 29A and the cap 31. That is, the control section 90 brings the water absorbing member 35 into contact with the nozzle surface 29A.

In step S17, the control section 90 determines whether or not a predetermined time has elapsed. The predetermined time may be set to, for example, 10 minutes to 30 minutes. The predetermined time may be set to less than 10 minutes. The predetermined time may be set to 30 minutes or more.

When the control section 90 determines that the predetermined time has not elapsed, the control section 90 shifts the process to step S17 again. When the control section 90 determines that the predetermined time has elapsed, the control section 90 shifts the process to step S18.

In step S18, the control section 90 executes a water absorbing member retreat process. In this process, the control section 90 controls the first motor 81 so as to move the cap 31 from the sealing position to the separation position. That is, the control section 90 moves the cap 31 so that the water absorbing member 35 is not in contact with the nozzle surface 29A. The control section 90 controls the second motor 82 such that the water absorbing member 35 is in the second state S2. By this, the second movement section 36 sets the water absorbing member 35 to the second state S2. That is, the control section 90 moves the water absorbing member 35 so that the water absorbing member 35 is not in contact with the nozzle surface 29A.

In step S19, the control section 90 executes a cleaning process. In this process, the control section 90 cleans the nozzle surface 29A. The control section 90 may execute a pressure cleaning. In the pressure cleaning, liquid in the ejection head 28 is pressurized to discharge the liquid from the ejection head 28. The pressure cleaning is maintenance in which liquid is forcibly discharged from the nozzle 29 to discharge air bubbles, foreign matter, and the like from the nozzle 29 together with liquid inside the ejection head 28. In this manner, the control section 90 may perform flushing by pressurizing liquid in the ejection head 28. When the cleaning is completed, the control section 90 controls the first motor 81 to move the cap 31 from the separation position to the sealing position.

In this way, a process of cleaning the nozzle surface 29A in step S19 without executing steps S15 to S18 corresponds to an example of a first cleaning process. A process of cleaning the nozzle surface 29A in step S19 after a predetermined time has elapsed from a state in which the water absorbing member 35 is sandwiched between the nozzle surface 29A and the cap 31 in the first state S1 in steps S15 to S18 corresponds to an example of a second cleaning process.

The control section 90 executes either the first cleaning process or the second cleaning process in accordance with an instruction from a worker. That is, the first cleaning process and the second cleaning process are selected in accordance with an instruction from a worker. The liquid ejection device 11 may receive an instruction by a worker from a terminal device.

### Operations and Effects of the First Embodiment

Operations and effects of the first embodiment will be described.
(1-1) The second movement section 36 can switch the water absorbing member 35 to the first state S1 in which the water absorbing member 35 is positioned between the nozzle surface 29A and the cap 31 by moving the water absorbing member 35. The second movement section 36 can switch water absorbing member 35 to the second state S2 in which the water absorbing member 35 is not positioned between the nozzle surface 29A and the cap 31 by moving the water absorbing member 35.

According to this configuration, the second movement section 36 can switch the water absorbing member 35 to either the first state S1 or the second state S2. By this, it is possible to improve the reliability of removing a solid substance solidified on the nozzle surface 29A. When the water absorbing member 35 is in the second state S2, the nozzle surface 29A can be covered with the cap 31. Therefore, the convenience of a worker can be improved.
(1-2) The second movement section 36 moves the water absorbing member 35 so that the opening section 44 is positioned between the nozzle surface 29A and the cap 31, thereby setting the water absorbing member 35 to the second state S2. According to this configuration, even when the water absorbing member 35 is positioned between the nozzle surface 29A and the cap 31, the nozzle surface 29A and the cap 31 can be brought into close contact with each other through the opening section 44. By this, the second state S2 can be achieved without moving the entire water absorbing member 35.
(1-3) The second movement section 36 includes the water absorbing member feed section 37 that feeds the water absorbing member 35 and the water absorbing member winding section 39 that winds the water absorbing member 35. According to this configuration, the second movement section 36 can switch the water absorbing member 35 to either the first state S1 or the second state S2 by feeding and winding the water absorbing member 35. This enables space saving in the device.

In addition, when the plurality of opening sections 44 are provided, the second movement section 36 can switch the water absorbing member 35 between the first state S1 and the second state S2 a plurality of times by transporting the water absorbing member 35 in the same rotation direction.
(1-4) The control section 90 executes either the first cleaning process or the second cleaning process in accordance with an instruction from a worker. According to this configuration, it is possible to execute either the first cleaning process or the second cleaning process as intended by the worker, in accordance with a state of the nozzle surface 29A. By this, it is possible to improve the reliability of removing a solid substance solidified on the nozzle surface 29A. Therefore, the convenience of a worker can be improved.

### Second Embodiment

Next, a second embodiment will be described. In the following description, redundant descriptions of configurations identical to those of the previously described embodiment will be omitted or simplified, and configurations that differ from the previously described embodiment will be detailed.

In the second embodiment, the control section 90 may be capable of executing the maintenance process even when the control section 90 does not receive an instruction from a worker. In the second embodiment, the control section 90 counts the number n of times of execution of the nozzle inspection process after the first cleaning process. The control section 90 starts the maintenance process with an initial value of the number n of times of execution set to zero.

### Maintenance Process

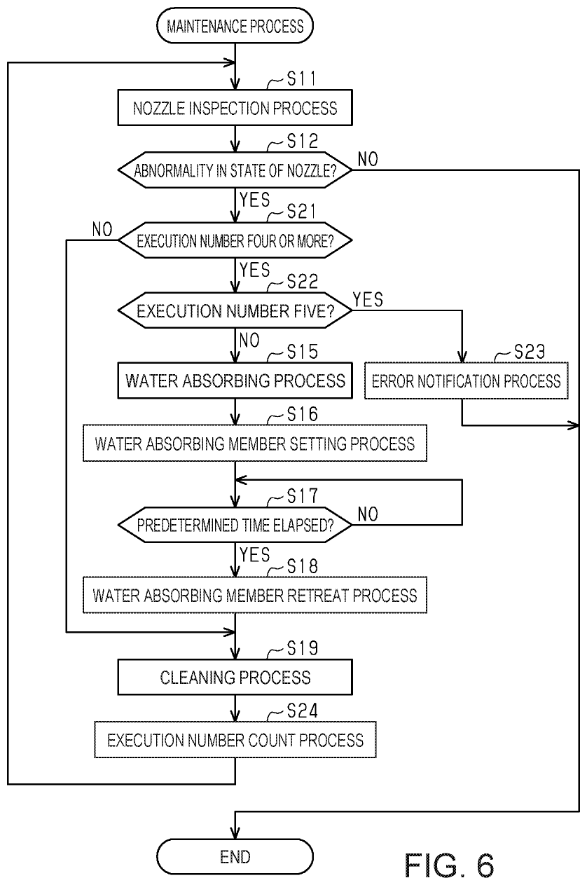

The maintenance process will be described with reference to FIG. 6. The maintenance process of the second embodiment is a process executed by the control section 90 at predetermined intervals as in the first embodiment.

As illustrated in FIG. 6, when the control section 90 determines that there is an abnormality in a state of the nozzle 29 in step S12, the control section 90 shifts the process to step S21. In step S21, the control section 90 determines whether or not the number n of times of execution is four or more. When the control section 90 determines that the number n of times of execution is less than four, the control section 90 shifts the process to step S19. When the control section 90 determines that the number n of times of execution is four or more, the control section 90 shifts the process to step S22.

In step S22, the control section 90 determines whether or not the number n of times of execution is five. When the control section 90 determines that the number n of times of execution is five, the control section 90 shifts the process to step S23. When the control section 90 determines that the number n of times of execution is not five, the control section 90 shifts the process to step S15.

In step S23, the control section 90 executes an error notification process. In this process, the control section 90 notifies a worker of an abnormality due to clogging of the nozzle 29 or the like. The control section 90 may display an error screen for prompting cleaning of the nozzle 29 on a display section (not illustrated) as a unit for notifying the abnormality.

When step S19 is completed, the control section 90 shifts the process to the step S24. In step S24, the control section 90 executes an execution number count process. In this process, the control section 90 may add one to the value of the number n of times of execution. The control section 90 adds one to the value of the number n of times of execution, and then shifts the process to step S11 again.

As described above, the control section 90 executes the second cleaning process when it is determined that a state of the nozzle 29 is not normal in the nozzle inspection process after the first cleaning process is executed a predetermined number of times. In the present embodiment, the predetermined number of times is four. The control section 90 performs error notification when it is determined that a state of the nozzle 29 is not normal in the nozzle inspection process after the second cleaning process is executed.

### Operation and Effect of Second Embodiment

An operation and effect of the second embodiment will be described.
(2-1) The control section 90 performs an operation of performing the nozzle inspection process after performing the first cleaning process n times, and performs the second cleaning process when it is determined that a state of the nozzle 29 is not normal in the nozzle inspection process of a predetermined number of times.

According to this configuration, when it is determined that a state of the nozzle 29 is not normal even after the first cleaning process is executed a predetermined number of times, the control section 90 executes the second cleaning process having a higher cleaning effect than the first cleaning process. Therefore, the convenience of a worker can be improved.

### Third Embodiment

Next, a third embodiment will be described.

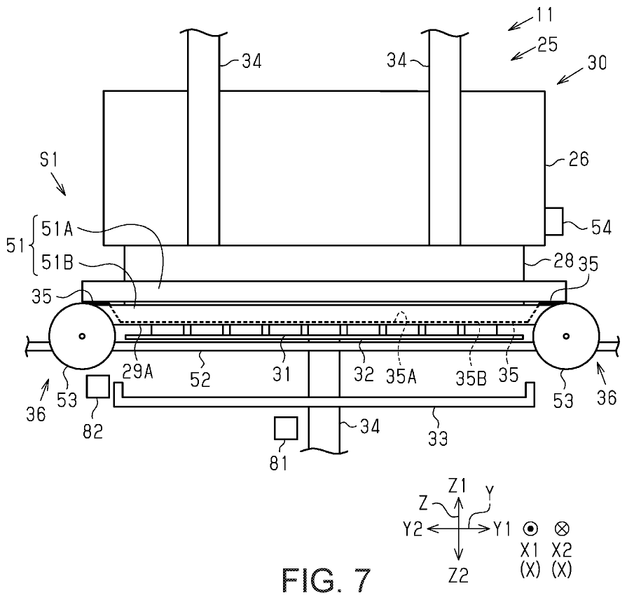

As illustrated in FIG. 7, in the third embodiment, the liquid ejection device 11 may include a holding section 51 and a second guide 52. The holding section 51 holds the water absorbing member 35. The holding section 51 may hold an end section of the water absorbing member 35 so as to expose the water absorbing member 35. The holding section 51 may have a rectangular parallelepiped shape. The holding section 51 may be constituted by a first holding section 51A and a second holding section 51B.

The first holding section 51A holds the water absorbing member 35 from the upward direction Z1. That is, the first holding section 51A is in contact with the first surface 35A. The second holding section 51B holds the water absorbing member 35 from the downward direction Z2. That is, the second holding section 51B is in contact with the second surface 35B. Accordingly, the holding section 51 holds the water absorbing member 35 from both sides of the upward direction Z1 and the downward direction Z2.

In a state where the water absorbing member 35 is held by the holding section 51, a part of a surface of the water absorbing member 35 on an upward direction Z1 side and a part of a surface of the water absorbing member 35 on a downward direction Z2 side are exposed from the holding section 51. An exposed surface of the water absorbing member 35 is larger than the nozzle surface 29A. That is, the holding section 51 is larger than the nozzle surface 29A.

The second guide 52 is supported by the housing 12, for example. The second guide 52 extends in one direction. The second guide 52 extends along the Y-axis in a region Z2 in the downward direction Z2 with respect to the cap 31, for example. The second guide 52 is, for example, a rod that is long along the Y-axis.

The holding section 51 is supported by the second guide 52 via a second movement section 53. The holding section 51 may be configured to be movable by the second movement section 53 along a direction in which the second guide 52 extends. The second movement section 53 may be driven by the second motor 82.

The second movement section 53 brings the water absorbing member 35 into the first state S1 by moving the holding section 51 so that the water absorbing member 35 is positioned between the nozzle surface 29A and the cap 31. The second movement section 53 brings the water absorbing member 35 into the second state S2 by moving the holding section 51 so that the water absorbing member 35 is not positioned between the nozzle surface 29A and the cap 31.

In the third embodiment, the liquid ejection device 11 includes a supply section 54 different from the supply section 41. The supply section 54 supplies the removal accelerating agent 43 to the water absorbing member 35. The supply section 54 supplies the removal accelerating agent 43 to the water absorbing member 35 before the water absorbing member 35 moves to a space between the nozzle surface 29A and the cap 31. The supply section 54 supplies the removal accelerating agent 43 to the water absorbing member 35 while the water absorbing member 35 changes from the second state S2 to the first state S1. Specifically, the supply section 54 supplies the removal accelerating agent 43 to the water absorbing member 35 while the second movement section 53 moves the water absorbing member 35 from a position not positioned between the nozzle surface 29A and the cap 31 to a position positioned between the nozzle surface 29A and the cap 31. The supply section 54 may be provided in the ejection head 28.

In the third embodiment, the first movement section 34 is connected to the carriage 26. The first movement section 34 is capable of moving the carriage 26 in the upward direction Z1 and the downward direction Z2 along the Z-axis. The first movement section 34 may be configured to move the ejection head 28 toward a cap 31 side by moving the carriage 26 along the Z-axis. The first movement section 34 may be capable of moving both the ejection head 28 and the cap 31. The first movement section 34 is connected to the carriage 26, and may not be connected to a downward direction Z2 side of the cap support section 32. In this manner, the first movement section 34 may be capable of moving at least one of the carriage 26 and the cap 31.

When the first movement section 34 moves the carriage 26 toward a cap 31 side, the first movement section 34 stops the movement of the carriage 26 in a state where the water absorbing member 35 is sandwiched between the ejection head 28 and the cap 31. At this time, the water absorbing member 35 is in the first state S1 and is in a state of being sandwiched between the nozzle surface 29A and the cap 31. That is, the control section 90 brings the water absorbing member 35 into contact with the nozzle surface 29A.

### Operation and Effect of Third Embodiment

An operation and effect of the third embodiment will be described.
(3-1) The second movement section 53 brings the water absorbing member 35 into the first state S1 by moving the holding section 51 so that the water absorbing member 35 is positioned between the nozzle surface 29A and the cap 31. The second movement section 53 brings the water absorbing member 35 into the second state S2 by moving the holding section 51 so that the water absorbing member 35 is not positioned between the nozzle surface 29A and the cap 31.

According to this configuration, the second movement section 53 can switch the water absorbing member 35 to either the first state S1 or the second state S2 by moving the holding section 51 along the second guide 52. Therefore, the convenience of a worker can be improved.

### Modifications

The present embodiment can be implemented with the following modifications. The embodiments and the following modifications can be implemented in combination with each other as long as there is no technical contradiction.

In the second embodiment, a predetermined number of times may be any natural number. A predetermined number of times may be set by an instruction of a worker, and in this case, an upper limit number of times may be set for the predetermined number of times. In the second embodiment, the error notification may be performed after the second cleaning process is executed a predetermined number of times. The predetermined number of times may be, for example, one time or two or more times.

In the second embodiment, the execution number count process may be a process of executing subtraction from the initial value. In this case, the initial value of the number n of times of execution may be set to an arbitrary natural number instead of zero. In step S21, the control section 90 may determine whether or not the number n of times of execution is equal to or less than one. In step S22, the control section 90 may determine whether or not the number n of times of execution is zero. The control section 90 may execute the error notification process when the control section 90 determines that the number n of times of execution is zero.

In the first embodiment and the second embodiment, the water absorbing member feed shaft 38 and the water absorbing member winding shaft 40 may rotate in opposite directions. That is, in the second movement section 36, the water absorbing member winding section 39 may feed the water absorbing member 35, and the water absorbing member feed section 37 may wind the water absorbing member 35.

In the first embodiment and the second embodiment, the supply section 54 in the third embodiment may be provided instead of the supply section 41. In this case, the supply section 54 may be provided in the ejection head 28.

In the third embodiment, the second guide 52 may extend in a direction along the first scanning direction X1. The second movement section 53 may move the holding section 51 on the XY plane. The second movement section 53 may be, for example, a roller that moves the holding section 51 on the XY plane.

In the third embodiment, the control section 90 may execute the maintenance process of the first embodiment and the second embodiment. In this case, in step S15, the control section 90 controls the supply section 54 to apply the removal accelerating agent 43 to the water absorbing member 35. The control section 90 controls the supply section 54 to supply the removal accelerating agent 43 to the water absorbing member 35, and then shifts the process to step S16. In this case, step S15 and a part of step S16 may be performed at the same time. Specifically, an operation of the second movement section 53 moving the holding section 51 on the XY plane and an operation of the supply section 54 applying the removal accelerating agent 43 to the water absorbing member 35 may be performed at the same time.

The control section 90 may move the ejection head 28 so that the water absorbing member 35 is not in contact with the nozzle surface 29A. The control section 90 may move at least one of the ejection head 28 and the cap 31 and move the water absorbing member 35 so that the water absorbing member 35 is not in contact with the nozzle surface 29A. In this manner, the control section 90 may move at least one of the ejection head 28 and the cap 31 or move the water absorbing member 35 so that the water absorbing member 35 is not in contact with the nozzle surface 29A.

The maintenance process may be executed when the cap 31 is arranged at the separation position. In this case, in step S16, the control section 90 may control the second motor 82 so that the water absorbing member 35 is in the first state S1 while the cap 31 is arranged at the separation position. In step S19, when the cleaning is completed, the control section 90 may not move the cap 31 from the separation position to the sealing position.

The maintenance process may be executed by the control section 90 when a print job is input, or may be executed by the control section 90 each time printing is completed, for example. The maintenance process may be executed by the control section 90 in response to an input of a maintenance job by a worker.

The first movement section 34 may move the carriage 26 along the Z-axis. The first movement section 34 may move the ejection head 28 along the Z-axis. By this, the first movement section 34 may adjust positions of the ejection head 28 and the cap 31.

The liquid ejection device 11 may be a serial printer. The serial head printer can eject liquid onto the medium 99 while the ejection head 28 moves along the Y-axis. The carriage 26 may be configured to move along the Y-axis. In this case, the first guide 24 extends in a direction along the first width direction Y1. The liquid ejection device 11 may be a line printer. A line head printer can eject liquid all at once to the entire medium 99 in the Y-axis by the ejection head 28 extending along the Y-axis.

The liquid ejection device 11 may be configured to move the medium support section 17. In this case, the medium support section 17 may be movable to a position facing the ejection head 28 and a position not facing the ejection head 28.

The liquid ejection device 11 may move the cap 31, the flushing receiving section 33, and the water absorbing member 35 to a region facing the ejection head 28. In this case, when the ejection head 28 is cleaned, the medium support section 17 may move to a position not facing the ejection head 28, and thus the cap 31, the flushing receiving section 33, and the water absorbing member 35 may move to a region facing the ejection head 28.

The liquid ejection device 11 may not include at least one of the water absorbing member 35, the second movement section 36, and the supply section 41. In this case, at least one of step S15, step S16, step S17, and step S18 may be performed by a hand of a worker.

The cleaning process of step S19 may include a wiping process of wiping the nozzle surface 29A with a wiper member.

The medium 99 may be any material such as a paper sheet, a roll body, a resin film or sheet, a resin-metal composite film, a laminate film, a textile, a nonwoven fabric, a metal foil, a metal film, a ceramic sheet, or a garment.

Liquid can be selected arbitrarily as long as it can be deposited to the medium 99 and used to print on the medium 99. The liquid may be a dye ink such as a disperse dye ink or a reactive dye ink. For example, ink includes ink in which particles of functional material made of solid substance such as pigment or metal particles are dissolved, dispersed, or mixed in a solvent, and includes various compositions such as water-based ink, oil-based ink, gel ink, and hot melt ink.

As used herein, the phrase “at least any” means one or more of the desired options. As an example, the phrase “at least any of” as used herein means only one option if the number of options is two, or both of the two options. As another example, the phrase “at least any” as used herein means only one option or a combination of any two or more options if the number of options is three or more.

### Notes

Hereinafter, technical ideas grasped from the above-described embodiment and modifications, and operations and effects thereof will be described. The present technical idea and the operations and effects thereof can be combined with each other within a technically consistent range.
(1) A liquid ejection device includes an ejection head including a nozzle surface in which is formed a nozzle that ejects liquid; a cap configured to seal the nozzle; a water absorbing member having a water absorbing property; a supply section that supplies, to the water absorbing member, a removal accelerating agent that accelerates removal of a solid substance resulting from solidification of liquid clinging to the nozzle surface; a first movement section configured to move at least one of the ejection head and the cap between a sealing position where the cap seals the nozzle and a separation position where the cap is separated from the nozzle; and a second movement section configured to move the water absorbing member to a position between the nozzle surface and the cap, wherein the second movement section is configured to, by moving the water absorbing member, switch the water absorbing member between a first state in which the water absorbing member is positioned between the nozzle surface and the cap and a second state in which the water absorbing member is not positioned between the nozzle surface and the cap.

According to this configuration, the second movement section can switch the water absorbing member to either the first state or the second state. When the water absorbing member is in the first state, the nozzle surface can be covered with the water absorbing member containing the removal accelerating agent. This makes it possible to improve the reliability of removing the solid substance solidified on the nozzle surface. When the water absorbing member is in the second state, the nozzle surface can be covered with the cap. Therefore, the convenience of a worker can be improved.
(2) The water absorbing member includes an opening section and the second movement section brings the water absorbing member into the second state by moving the water absorbing member so that the opening section is positioned between the nozzle surface and the cap.

According to this configuration, even when the water absorbing member is positioned between the nozzle surface and the cap, the nozzle surface and the cap can be brought into close contact with each other through the opening section.
(3) The second movement section includes a water absorbing member feed section that feeds the water absorbing member and a water absorbing member winding section that winds the water absorbing member.

According to this configuration, the second movement section can switch the water absorbing member to either the first state or the second state by feeding and winding the water absorbing member. This enables space saving in the device. Therefore, the convenience of a worker can be improved.
(4) The liquid ejection device further includes a holding section that holds the water absorbing member, wherein the second movement section brings the water absorbing member into the first state by moving the holding section so that the water absorbing member is positioned between the nozzle surface and the cap and brings the water absorbing member into the second state by moving the holding section so that the water absorbing member is not positioned between the nozzle surface and the cap.

According to this configuration, the second movement section can switch the water absorbing member to either the first state or the second state by moving the holding section. Therefore, the convenience of a worker can be improved.
(5) The liquid ejection device further includes a control section, wherein the control section executes, in accordance with an instruction from a worker, either a first cleaning process of cleaning the nozzle surface or a second cleaning process of cleaning the nozzle surface after a predetermined time has elapsed from a state in which the water absorbing member is sandwiched between the nozzle surface and the cap in the first state.

According to this configuration, it is possible to execute either the first cleaning process or the second cleaning process as intended by a worker, in accordance with a state of the nozzle surface. This makes it possible to improve the reliability of removing the solid substance solidified on the nozzle surface. Therefore, the convenience of a worker can be improved.
(6) The liquid ejection device further includes a control section, wherein the control section is configured to execute a nozzle inspection process of inspecting a state of the nozzle, a first cleaning process of cleaning the nozzle surface, and a second cleaning process of cleaning the nozzle surface after a predetermined time has elapsed from a state in which the water absorbing member is in the first state and the water absorbing member is sandwiched between the nozzle surface and the cap and the control section executes the second cleaning process when the state of the nozzle is determined to be not normal in the nozzle inspection process after the first cleaning process is executed a predetermined number of times.

According to this configuration, when it is determined that a state of the nozzle is not normal even after the first cleaning process is executed a predetermined number of times, the control section executes the second cleaning process having a higher cleaning effect than the first cleaning process. Therefore, the convenience of a worker can be improved.
(7) A nozzle surface cleaning method for a printing device that includes an ejection head including a nozzle surface in which is formed a nozzle that ejects liquid, a cap configured to seal the nozzle, and a movement section configured to move at least one of the ejection head and the cap between a sealing position where the cap seals the nozzle and a separation position where the cap is separated from the nozzle, the nozzle surface cleaning method includes a step of moving at least one of the ejection head and the cap so that the cap is positioned at the separation position separated from the nozzle; a step of bringing the water absorbing member, which absorbed a removal accelerating agent that accelerates removal of a solid substance resulting from solidification of liquid clinging to the nozzle surface, into contact with the nozzle surface; a step of moving at least one of the ejection head and the cap or moving the water absorbing member so that the water absorbing member is not in contact with the nozzle surface; and a step of performing flushing in which liquid is ejected from the nozzle.

According to this configuration, it is possible to achieve the same effect as (1).

What is claimed is:

1. A liquid ejection device comprising:
an ejection head including a nozzle surface in which is formed a nozzle that ejects liquid;
a cap configured to seal the nozzle;
a water absorbing member having a water absorbing property;
a supply section that supplies, to the water absorbing member, a removal accelerating agent that accelerates removal of a solid substance resulting from solidification of liquid clinging to the nozzle surface;
a first movement section configured to move at least one of the ejection head and the cap between a sealing position where the cap seals the nozzle and a separation position where the cap is separated from the nozzle; and
a second movement section configured to move the water absorbing member to a position between the nozzle surface and the cap, wherein
the second movement section is configured to, by moving the water absorbing member, switch the water absorbing member between a first state in which the water absorbing member is positioned between the nozzle surface and the cap and a second state in which the water absorbing member is not positioned between the nozzle surface and the cap.

2. The liquid ejection device according to claim 1, wherein
the water absorbing member includes an opening section and
the second movement section brings the water absorbing member into the second state by moving the water absorbing member so that the opening section is positioned between the nozzle surface and the cap.

3. The liquid ejection device according to claim 2, wherein
the second movement section includes
a water absorbing member feed section that feeds the water absorbing member and
a water absorbing member winding section that winds the water absorbing member.

4. The liquid ejection device according to claim 1, further comprising:
a holding section that holds the water absorbing member, wherein
the second movement section
brings the water absorbing member into the first state by moving the holding section so that the water absorbing member is positioned between the nozzle surface and the cap and
brings the water absorbing member into the second state by moving the holding section so that the water absorbing member is not positioned between the nozzle surface and the cap.

5. The liquid ejection device according to claim 1, further comprising:
a control section, wherein
the control section executes, in accordance with an instruction from a worker, either a first cleaning process of cleaning the nozzle surface or a second cleaning process of cleaning the nozzle surface after a predetermined time has elapsed from a state in which the water absorbing member is sandwiched between the nozzle surface and the cap in the first state.

6. The liquid ejection device according to claim 1, further comprising:
a control section, wherein
the control section is configured to execute
a nozzle inspection process of inspecting a state of the nozzle,
a first cleaning process of cleaning the nozzle surface, and
a second cleaning process of cleaning the nozzle surface after a predetermined time has elapsed from a state in which the water absorbing member is in the first state and the water absorbing member is sandwiched between the nozzle surface and the cap and
the control section executes the second cleaning process when the state of the nozzle is determined to be not normal in the nozzle inspection process after the first cleaning process is executed a predetermined number of times.

7. A nozzle surface cleaning method for a printing device that includes
an ejection head including a nozzle surface in which is formed a nozzle that ejects liquid,
a cap configured to seal the nozzle, and
a movement section configured to move at least one of the ejection head and the cap between a sealing position where the cap seals the nozzle and a separation position where the cap is separated from the nozzle,
the nozzle surface cleaning method comprising:
a step of moving at least one of the ejection head and the cap so that the cap is positioned at the separation position separated from the nozzle;
a step of bringing the water absorbing member, which absorbed a removal accelerating agent that accelerates removal of a solid substance resulting from solidification of liquid clinging to the nozzle surface, into contact with the nozzle surface;
a step of moving at least one of the ejection head and the cap or moving the water absorbing member so that the water absorbing member is not in contact with the nozzle surface; and
a step of performing flushing in which liquid is ejected from the nozzle.
